(19) United States
(12) Patent Application Publication
(10) Pub. No.: US 2007/0267836 A1
(43) Pub. Date: Nov. 22, 2007

(54) NON-SYMMETRICAL TAPERED MONO-LEAF SPRING

(75) Inventors: Christopher K. Furman, Augusta, GA (US); James Agerton, Augusta, GA (US); Warren Clark, Evans, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/419,363

(22) Filed: May 19, 2006

(51) Int. Cl. B60G 7/00

(52) U.S. Cl. 280/124.17

(57) ABSTRACT

A mono-leaf spring for a golf car includes a homogenous body. The homogenous body includes: a substantially planar portion; a first bend portion extending from the planar portion to a first distal end, the first bend portion having a first length; and a second bend portion oppositely extending from the planar portion with respect to the first bend portion to a second distal end, the second bend portion having a second length. A wall thickness of each of the first and second bend portions continuously decreases from the planar portion to each of the first and second distal ends.

### FIELD

The present disclosure relates to devices and methods for using leaf spring assemblies, for example, in golf car and off-road utility vehicles.

### BACKGROUND

The statements in this section merely provide background information related to the present disclosure and may not constitute prior art.

Golf cars and many off-road or utility vehicles commonly have rigid or single axle suspension systems for both the front steerable wheels and the rear driving wheels. Rear suspensions for these vehicles are most commonly multiple/stacked leaf springs and/or coiled springs used to support the solid axle. The leaf springs are used to promote side-to-side and bounce stability of the suspension. Shock absorbers dampen the leaf spring travel and frequency which therefore promote a more stable and comfortable ride feel.

Leaf spring assemblies commonly include multiple leaf plates which must be frictionally joined by clamp elements or fasteners, which increase the complexity and costs of the assemblies. The junctions between the various leaf plates are also areas of increased moisture entrapment and friction and therefore corrosion potential. A single leaf spring design can eliminate the corrosion problem between plates.

### SUMMARY

According to several embodiments of the present disclosure, a mono-leaf spring for a golf car includes a homogenous body. The homogenous body includes: a substantially planar portion; a first bend portion extending from the planar portion to a first distal end, the first bend portion having a first length; and a second bend portion oppositely extending from the planar portion with respect to the first bend portion to a second distal end, the second bend portion having a second length. A wall thickness of each of the first and second bend portions continuously decreases from the planar portion to each of the first and second distal ends.

According to other embodiments, a suspension system for a golf car includes first and second mono-leaf springs, each having a homogenous body. The homogenous body includes a substantially planar portion. A first bend portion extends from the planar portion to a first distal end, the first bend portion having a first length. A second bend portion oppositely extends from the planar portion with respect to the first bend portion to a second distal end. The second bend portion has a second length shorter than the first length. A wall thickness of each of the first and second bend portions continuously decreases from the planar portion to each of the first and second distal ends. A first rolled end is created at the first distal end. A second rolled end is created at the second distal end. A link assembly connects the first rolled end of each of the first and second leaf springs to a frame of the golf car. A bracket assembly connects the second rolled end of each of the first and second leaf springs to the golf car.

According to still other embodiments, a golf car includes a frame having first and second frame members and first and second mono leaf springs. The first mono leaf spring is connected to the first frame member and the second mono leaf spring is connected to the second frame member. Each of the first and second mono leaf springs further include: a substantially planar portion; a first bend portion extending from the planar portion to a first distal end, the first bend portion having a first length; and a second bend portion oppositely extending from the planar portion with respect to the first bend portion to a second distal end. The second bend portion has a second length shorter than the first length. A wall thickness of each of the first and second bend portions continuously decreases from the planar portion to each of the first and second distal ends. A first rolled end is created at the first distal end and a second rolled end created at the second distal end. An axle housing rotatably supports first and second wheels. First and second support plates couple the first and second mono leaf springs to the axle housing.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a golf car having the non-symmetrical tapered mono-leaf spring according to various embodiments of the present disclosure;

FIG. 2 is a bottom plan view of the golf car of FIG. 1;

FIG. 3 is a top plan view of the non-symmetrical tapered mono-leaf spring according to various embodiments of the present disclosure;

FIG. 4 is a side elevational view of the spring of FIG. 3; and

FIG. 5 is a partial perspective view of a golf car frame and suspension system incorporating the non-symmetrical tapered mono-leaf spring of the present disclosure.

### DETAILED DESCRIPTION

The following description is merely exemplary in nature and is in no way intended to limit the present disclosure, application, or uses. Throughout this specification, like reference numerals will be used to refer to like elements. As referred to herein, the term “golf car” is synonymously used to describe application of the present disclosure to golf cars as well as sport utility vehicles such as modified golf cars, used for example as food and/or beverage cars, golf cars adapted for use as hunting/sporting clays vehicles, golf course maintenance vehicles, and the like.

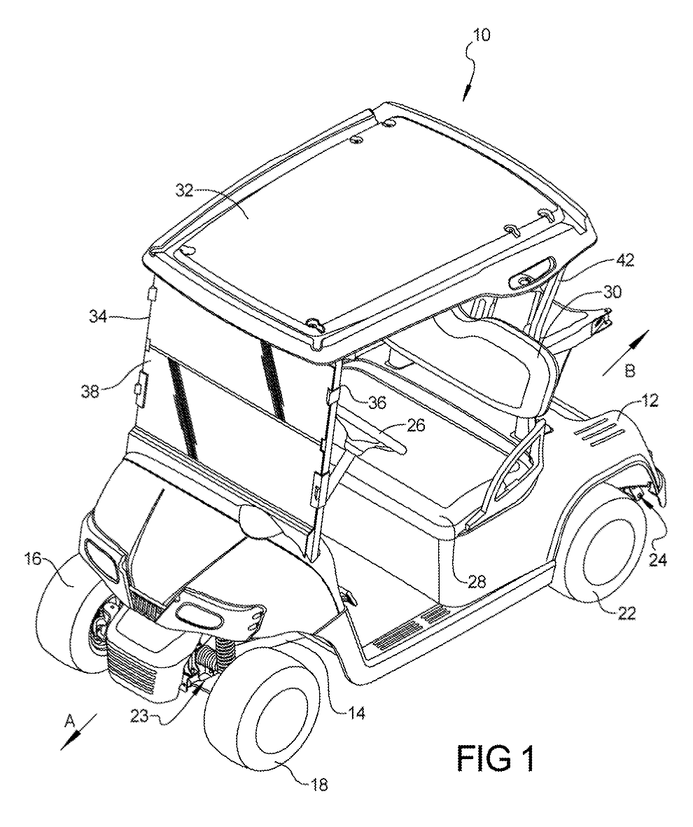

Referring generally to FIG. 1, a golf car 10 can include a body 12 supported from a structural frame 14. Frame 14 can also support a plurality of wheels including a first steerable wheel 16 and a second steerable wheel 18. In addition, powered or driven wheels including a first driven wheel 20 and a second driven wheel 22 are commonly connected to a rear structural portion of frame 14. A front suspension system 23 can also be provided which is adapted for supporting each of the first and second steerable wheels 16, 18. A rear suspension system 24 can also be provided which is adapted for supporting each of the first and second driven wheels 20, 22 from frame 14. A steering mechanism 26 which commonly includes a steering wheel and a support post assembly is also included to provide the necessary steering input to first and second steerable wheels 16, 18.

Golf car 10 can also include a passenger bench seat 28 and a passenger back support cushion 30. A cover or roof 32 can also be provided which is supported from either body 12 or frame 14 by first and second support members 34, 36. A windscreen or windshield 38 can also be provided which is also supported by each of first and second support members 34, 36. A rear section of roof 32 can be supported by each of a first and a second rear support element 40, 42. Other items provided with golf car 10 include golf bag support equipment, accessory racks or bins, headlights, side rails, fenders, and the like.

Golf car 10 is commonly propelled by a power unit such as an engine or battery/motor system which is commonly provided below and/or behind bench seat 28. Golf car 10 is capable of motion in either of a forward direction “A” or a rearward direction “B”. Each of first and second driven wheels 20, 22 can be commonly supported to frame 14 using rear suspension system 24. Each of first and second steerable wheels 16, 18 can be independently or commonly supported to frame 14, therefore the present disclosure is not limited by the design of front suspension system 23.

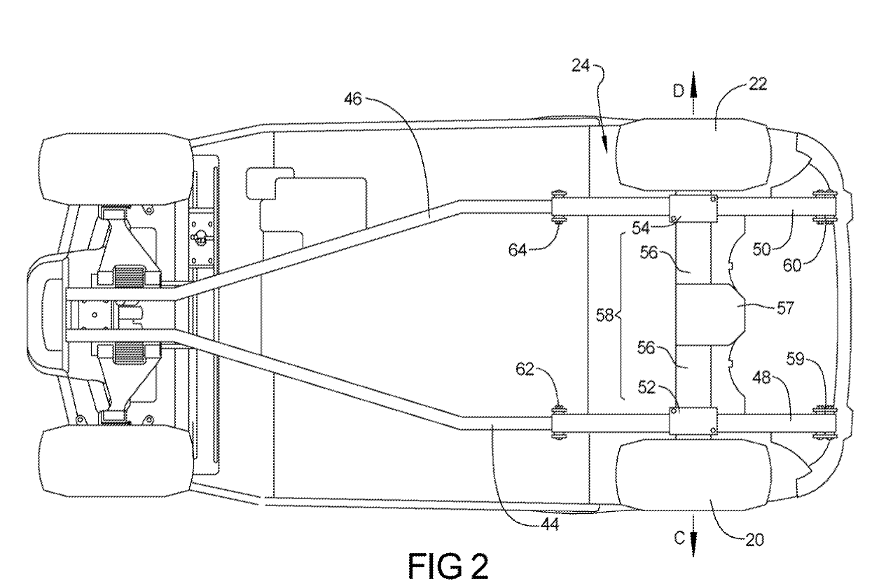

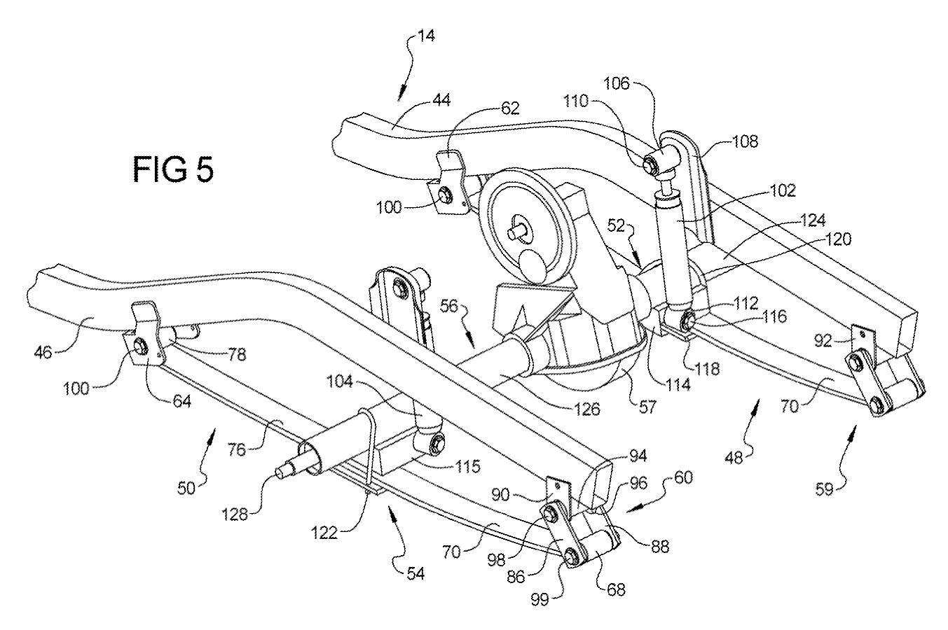

As best seen in reference to FIG. 2, frame 14 can further include a longitudinally arranged first frame member 44 and a second frame member 46. First and second frame members 44, 46 can be hollow, tubular shaped members created of a steel material or similar structural material and formed by welding, extruding, hydroforming, or similar processes. A first and second non-symmetrical leaf spring assembly 48, 50 support each of first and second driven wheels 20, 22. A first shock support assembly 52 can be connected to first non-symmetrical leaf spring assembly 48 and first frame member 44. Similarly, a second shock support assembly 54 can be connected to second non-symmetrical leaf spring assembly 50 and second frame member 46. Each of first and second shock support assemblies 52, 54 are also connected to an axle housing 56 within which an axle (shown in FIG. 5) is rotatably disposed for providing driving power to the first and second driven wheels 20, 22 through a gear train or transmission 57 connected to the power unit.

First and second non-symmetrical leaf spring assemblies 48, 50 can be connected at a rearward facing end to first and second frame members 44, 46 by each of a first and second link assembly 59, 60. In addition, first and second non-symmetrical leaf spring assemblies 48, 50 can be connected at a forward facing end to first and second frame members 44, 46 by each of a first and second bracket assembly 62, 64. The use of first and second non-symmetrical leaf spring assemblies 48, 50 further helps reduce deflection of the rear suspension system 24 in either of a first or second deflection direction “C” or “D”.

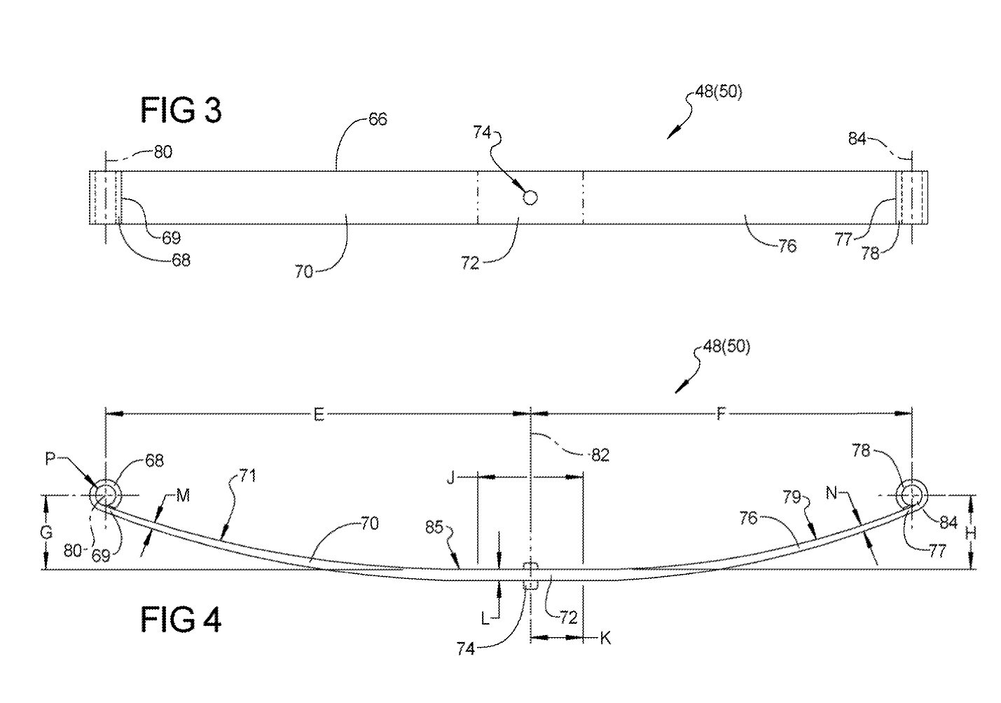

Referring now to FIGS. 3 and 4, first non-symmetrical leaf spring assembly 48 is shown in greater detail. Second non-symmetrical leaf spring assembly 50 is essentially identical to first non-symmetrical leaf spring assembly 48 and therefore the following discussion applies to both first and second non-symmetrical leaf spring assemblies 48, 50. First non-symmetrical leaf spring assembly 48 includes a homogenous, single leaf spring body 66. A first rolled end 68 is created by bending or rolling a first distal end 69 of a first bend portion 70. First bend portion 70 defines a first concaved curving surface 71 from which first rolled end 68 extends away from. A planar portion 72 is integrally joined to first bend portion 70. Planar portion 72 also includes a pin 74 which is welded or otherwise fixedly connected to spring body 66 in planar portion 72 and extends substantially perpendicular to planar portion 72. The purpose for pin 74 will be described in reference to FIG. 5. Integrally extending from planar portion 72 is a second bend portion 76. A second rolled end 78 created similar to first rolled end 68 is positioned at a second distal end 77 of second bend portion 76. Second bend portion 76 defines a second concaved curving surface 79 from which second rolled end 78 extends away from.

First rolled end 68 defines a substantially circular cross-section having a first longitudinal axis 80. A longitudinal pin axis 82 is defined coaxially through a center of pin 74. A first bend portion length “E” is defined between first longitudinal axis 80 and pin axis 82. Similarly, second rolled end 78 also defines a substantially circular shape having a second longitudinal axis 84. Second longitudinal axis 84 is positioned with respect to pin axis 82 by a second bend portion length “F”. According to several embodiments of the present disclosure, first bend portion length “E” is greater than second bend portion length “F” defining a non-symmetrical geometry for spring body 66. According to several embodiments of the present disclosure, first bend portion length “E” is approximately 401.7 mm. Second bend portion length “F” according to several embodiments is approximately 372.3 mm. The difference in length between first and second portion lengths “E”, “F” provides the ability to tune the deflection of first and second non-symmetrical leaf spring assemblies 48, 50. A first end displacement dimension “G” is provided between first longitudinal axis 80 and a first surface 85 of substantially flat, planar portion 72. Similarly, a second end displacement dimension “H” is defined between second longitudinal axis 84 and first surface 85. According to several embodiments of the present disclosure, first end displacement dimension “G” is approximately 63.5 mm and second end displacement dimension “H” Is approximately 76.2 mm. The difference between the first and second end displacement dimensions “G” and “H” allow for different connection points to frame 14.

According to several embodiments, spring body 66 defines a substantially continuously decreasing thickness between planar portion 72 and each of first rolled end 68 and second rolled end 78, respectively. Because first bend portion length “E” is greater than second bend portion length “F” the taper defined between planar portion 72 and first rolled end 68 defines a more gradually decreasing rate of thickness change than the more rapidly decreasing rate of thickness change between planar portion 72 and second rolled end 78.

According to several embodiments, planar portion 72 has a planar portion length “J” and pin 74 is substantially centrally positioned within planar portion 72 such that a pin spacing dimension “K” is approximately one-half of planar portion length “J”. The present disclosure is not limited by the location of pin 74, and in several embodiments pin 74 can be positioned at substantially any location in planar portion 72. In several embodiments, planar portion 72 has a planar portion thickness “L”, first bend portion 70 has a first end minimum thickness “M”, and second bend portion 76 has a second end minimum thickness “N”. According to several embodiments, planar portion length “J” is approximately 101.6 mm, pin spacing dimension “K” is approximately 50.8 mm, planar portion thickness “L” is approximately 10.2 mm, first end minimum thickness “M” is approximately 5.5 mm, and second end minimum thickness “N” is also approximately 5.5 mm. The varying wall thicknesses of first and second bend portions 70, 76 distribute load stresses equally between pin 74 and either of first or second rolled ends 68, 78. A continuous taper also ensures maximum fatigue life for spring body 66 by evenly distributing the stresses. Also, each of first and second rolled ends 68, 78 have a rolled end through-diameter “P”. According to several embodiments, through-diameter “P” is approximately 22.4 mm. This diameter is selected to correspond to an outside diameter of the fasteners or pins used to install spring body 66 in golf car 10.

Referring generally to FIG. 5, an exemplary installation of rear suspension system 24 provides substantially identical configurations of first and second link assemblies 59, 60. Each of first and second link assemblies 59, 60 can include a first link 86 rotatably connected to a first flange 90, and a second link 88 rotatably connected to a second flange 92. First and second flanges 90, 92 can be fixedly connected to one of first or second frame members 44, 46. A sleeve 94 can also be positioned between each of first and second flanges 90, 92 to maintain the appropriate spacing for first and second links 86, 88. At least one washer 96 can be disposed between distal ends of sleeve 94 and each of first and second links 86, 88 as well as at distal ends of first rolled end 68 of spring body 66. Washers 96 can be a polymeric material having a low co-efficient of friction such as a polyamide material.

To assemble first and second non-symmetrical leaf spring assemblies 48, 50, a first fastener 98 is inserted through first link 86, first flange 90, sleeve 94, and second link 88. Similarly, a second fastener 99 is inserted through first link 86, first rolled end 68, and second link 88. Washers 96 can also be installed during this assembly stage. At a forward distal end of both first and second non-symmetrical leaf spring assemblies 48, 50 first and second bracket assemblies 62, 64 are initially fixedly connected to either first or second frame member 44, 46 respectively. A third fastener 100 is slidably disposed through second bracket assembly 64 and second rolled end 78. Vertical deflections of first and second non-symmetrical leaf spring assemblies 48, 50 are accommodated by forward and rearward deflections of first rolled end 68 with respect to either first or second link assemblies 59, 60.

Each of first and second shock support assemblies 52, 54 are substantially identical with some parts configured in mirror image as will be described further herein. First and second shock support assemblies 52, 54 include a first shock absorber 102 and a second shock absorber 104 respectively. Each of the first and second shock absorbers 102, 104 include a first connecting sleeve 106 connected to a frame extension 108 using a bolt 110. Further, each of first and second shock absorbers 102, 104 further include a second connecting sleeve 112 connected to either a first or a second support bracket 114, 115. A support plate 118 can be positioned below each of first and second support brackets 114, 115 to engage either first or second non-symmetrical leaf spring assembly 48, 50 between the support plate 118 and either first or second support bracket 114, 115. An aperture (not shown) created in both support plates 118 can receive pin 74 of first and second non-symmetrical leaf spring assemblies 48, 50. Pin 74 therefore fixes a configuration of first and second non-symmetrical leaf spring assemblies 48, 50 with respect to axle housing 56. A U-bolt 120 is positioned about axle housing 56 having its distal ends extending through apertures of support plate 118 to be engaged by a plurality of nuts 122. When torqued, nuts 122 draw axle housing 56, first or second support bracket 114, 115, either first or second non-symmetrical leaf spring assembly 48 or 50, and support plate 118 into an engaged contact.

Axle housing 56 is further distinguishable as each of a first housing portion 124 and a second housing portion 126 divided about transmission 57. First shock support assembly 52 is engaged with first housing portion 124 and second shock support assembly 54 is engaged with second housing portion 126. The lengths of first and second housing portions 124, 126 can vary. An axle 128 is rotatably disposed within axle housing 56 and rotated by transmission 57 to power each of first and second driven wheels 20, 22. Axle 128 can also be a two part axle, having separate parts disposed in each of first and second housing portions 124, 126.

In several embodiments, first support bracket 114 is substantially identical to second support bracket 115 and in several embodiments are mirror images of each other. This permits the first and second shock absorbers 102, 104 to be oriented as shown in FIG. 5 with clearance about support plates 118 and either first or second non-symmetrical leaf spring assemblies 48, 50 for installation of the first or second shock absorbers 102, 104.

Spring body 66 of both first and second non-symmetrical leaf spring assemblies 48, 50 is each created from a metal such as spring steel and rolled or pressed to create the continuously decreasing taper (thickness) between the planar portion 72 and both first and second rolled ends 68, 78. Pin 74 can be a metal such as steel and is positioned following formation of the spring body 66 by initially creating an aperture in planar portion 72 through which pin 74 is positioned and then welding or otherwise fixedly connecting pin 74 to planar portion 72. The difference between first and second end displacement dimensions “G” and “H” can be varied depending upon the geometry of rear suspension system 24 and a desired vertical position of axle housing 56 with respect to frame 14. The dimensions provided herein are for example only and do not limit the present disclosure.

First and second non-symmetrical leaf spring assemblies 48, 50 of the present disclosure offer several advantages. By positioning a planar portion of the mono-leaf spring closer to one of the rolled ends and continuously decreasing a thickness from the planar portion toward either rolled end, the leaf springs of the present disclosure provide a varying profile between either rolled end and the planar portion, while distributing load stresses in either of the bend portions substantially equally. This balances the load induced by axle housing 56 to planar portion 72 and the connections of first and second rolled ends 68, 78 to frame 14. This also permits the geometry of rear suspension system 24 to accommodate different front-to-back and/or vertical positions of axle housing 56 with respect to frame 14 while maintaining substantially equal stress loads on either of the bend portions of the leaf spring. Non-symmetrical mono leaf springs of the present disclosure also provide for different end displacement dimensions allowing for different connection heights to both the frame and link assemblies.

The description herein is merely exemplary in nature and, thus, variations that do not depart from the gist of that which is described are intended to be within the scope of the disclosure. Such variations are not to be regarded as a departure from the spirit and scope of the disclosure.

1. A mono-leaf spring for a golf car, comprising:
a homogenous body including:
a substantially planar portion;
a first bend portion extending from the planar portion to a first distal end, the first bend portion having a first length; and
a second bend portion oppositely extending from the planar portion with respect to the first bend portion to a second distal end, the second bend portion having a second length; and
a wall thickness of each of the first and second bend portions continuously decreases from the planar portion to each of the first and second distal ends.

2. The leaf spring of claim 1, wherein the first length is greater than the second length.

3. The leaf spring of claim 2, further comprising:
a first rolled end created at the first distal end; and
a second rolled end created at the second distal end.

4. The leaf spring of claim 3, wherein each of the first and second rolled ends further comprise a through-diameter sized to correspond to a diameter of a fastener insertable through any of the first and second rolled ends.

5. The leaf spring of claim 1, wherein the body comprises a metal material.

6. The leaf spring of claim 5, wherein the metal material further comprises a spring steel.

7. The leaf spring of claim 1, further comprising a pin fixedly connected to the planar portion and extending substantially perpendicular to the planar portion.

8. The leaf spring of claim 1, wherein the planar portion comprises a substantially constant thickness throughout a length of the planar portion.

9-15. (canceled)

16. A golf car, comprising:
a frame having first and second frame members;
first and second mono leaf springs, the first mono leaf spring connected to the first frame member and the second mono leaf spring connected to the second frame member, each of the first and second mono leaf springs further including:
a substantially planar portion;
a first bend portion extending from the planar portion to a first distal end, the first bend portion having a first length;
a second bend portion oppositely extending from the planar portion with respect to the first bend portion to a second distal end, the second bend portion having a second length shorter than the first length;
a wall thickness of each of the first and second bend portions continuously decreasing from the planar portion to each of the first and second distal ends;
a first rolled end created at the first distal end; and
a second rolled end created at the second distal end;
an axle housing rotatably supporting first and second wheels; and
first and second support plates coupling the first and second mono leaf springs to the axle housing.

17. The golf car of claim 16, further comprising first and second support brackets fixedly connected to the axle housing each operable to engage one of the first and second mono leaf springs.

18. The golf car of claim 17, wherein each of the first and second support brackets receive a pin fixedly engaged with one of the first and second mono leaf springs.

19. The golf car of claim 17, further comprising:
a first shock absorber connected between the first support bracket and the first frame member; and
a second shock absorber connected between the second support bracket and the second frame member.

20. The golf car of claim 16, further comprising a U-bolt operable to engage each of the first and second support plates to the axle housing.

21. A method for creating a suspension system of a golf car, the suspension system including first and second mono leaf springs each having a planar portion and first and second bend portions oppositely extending away from the planar portion, the method comprising:
extending a first length of the first bend portion greater than a second length of the second bend portion;
rolling a distal end of the each of the first and second mono leaf springs;
continuously decreasing a thickness of each of the first and second bend portions away from the planar portion toward each of the distal ends;
maintaining a first minimum wall thickness of the first bend portion proximate the first distal end substantially equal to a second minimum wall thickness of the second bend portion proximate the second distal end to equally distribute a load stress applied to each of the first and second mono leaf springs equally between the first and second bend portions; and
fastening each rolled distal end of each of the first and second mono leaf springs to a frame of the golf car.

22. The method of claim 21, further comprising fixedly connecting first and second support brackets to an axle housing.

23. The method of claim 22, further comprising coupling each of the first and second mono leaf springs to one of the support brackets using one of a first and second support plate.

24. The method of claim 23, further comprising connecting each of a first and second shock absorber to one of the first and second support brackets.

25. The method of claim 23, further comprising engaging the planar portion of each of the first and second mono leaf springs to one of the first and second support plates.

26. The method of claim 21, further comprising creating a concaved curved surface in each of the first and second bend portions.

27. A suspension system for a golf car, comprising:
at least one homogenous mono-leaf spring body including:
a substantially planar portion;
a first bend portion extending from the planar portion to a first distal end, the first bend portion having a first length; and
a second bend portion oppositely extending from the planar portion with respect to the first bend portion to a second distal end, the second bend portion having a second length different from the first length; and
a wall thickness of each of the first and second bend portions continuously decreasing from the planar portion to each of the first and second distal ends; and
a first minimum wall thickness of the first bend portion proximate the first distal end and a second minimum wall thickness of the second bend portion proximate the second distal end being substantially equal, operable to equally distribute a load stress of the mono-leaf spring substantially equally in each of the first and second bend portions.

28. The suspension system of claim 27, wherein a difference between the first bend portion length and the second bend portion length is variable to operably tune a deflection of the mono-leaf spring body.

29. The suspension system of claim 28, further comprising a pin fixedly connected to the planar portion and extending substantially perpendicular to the planar portion, the pin defining a pin axis operable to define the first and second bend portion lengths measurable from the pin axis.

30. The suspension system of claim 27, further comprising:
the at least one homogenous mono-leaf spring body including first and second spring bodies operable to support each of first and second wheels;
an axle housing rotatably supporting the first and second wheels; and
first and second support plates, the first support plate supporting the first leaf spring to the axle housing and the second support plate supporting the second leaf spring to the axle housing.

31. The suspension system of claim 30, wherein the planar portion comprises a substantially constant thickness throughout a length of the planar portion, the planar portion being engaged with one of the first and second support plates.
